(19) United States
(12) Patent Application Publication
(10) Pub. No.: US 2009/0279284 A1
(43) Pub. Date: Nov. 12, 2009

(54) ILLUMINATION DEVICE, LIGHT SOURCE DEVICE USED FOR THE SAME, AND LIQUID CRYSTAL DISPLAY EQUIPPED WITH THE ILLUMINATION DEVICE

(75) Inventors: Seiji Takeuchi, Matsusaka-shi (JP); Tetsuya Hamada, Matsusaka-shi (JP); Noriyuki Ohashi, Taki-gun (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/089,974

(22) PCT Filed: Jul. 19, 2006
(86) PCT No.: PCT/JP2006/314268

§ 371 Date: Apr. 11, 2008

(30) Foreign Application Priority Data
Oct. 14, 2005 (JP) 2005-300743

(51) Int. Cl. G09F 13/08; F21K 7/00

(52) U.S. Cl. 362/97.3; 362/231

(57) ABSTRACT

In the case where RGB light emitting elements are used as light sources of a surface emitting type illumination device, the occurrence of color irregularity in the vicinity of a light incident surface is prevented, so that uniform white light is obtained on an entire light outgoing surface. In a light source device including light emitting elements of respective colors including red light emitting elements, green light emitting elements, and blue light emitting elements that emit light in a red (R) wavelength range, light in a green (G) wavelength range, and light in a blue (B) wavelength range, respectively, the light emitting elements being provided on one principal surface of a substrate, the light emitting elements of the respective colors are aligned in a longitudinal direction of the substrate, the number of the green light emitting elements is larger than the number of each of the red light emitting elements and the blue light emitting elements, and the light emitting elements of the respective colors in the longitudinal direction of the substrate are aligned at regular Intervals for each of the colors.

### TECHNICAL FIELD

The present invention relates to an illumination device of a so-called surface emitting type that emits plane-shaped light, a light source device used for the same, and a liquid crystal display equipped with the illumination device.

### BACKGROUND ART

In recent years, a liquid crystal display having features such as low power consumption, thinness, and light weight has been used widely as a display device of television receivers, personal computers, mobile telephones, and the like. A liquid crystal display element is a so-called non-light-emitting display element that does not emit light itself. Thus, a surface emitting type illumination device (so-called backlight) is provided, for example, on one principal surface of a liquid crystal display element, or alternatively, ambient light is allowed to enter a liquid crystal display element as illumination light. The former configuration is referred to as a transmission liquid crystal display, and the latter configuration is referred to as a reflection liquid crystal display. In addition to these, a so-called semi-transmission liquid crystal display also has been known conventionally, which uses ambient light as illumination light and uses illumination light from a backlight as well if necessary.

A backlight is classified roughly into a direct type and a sidelight (also referred to as an edge-light) type depending on the arrangement of a light source with respect to a liquid crystal display element. A direct type backlight is configured such that a light source is arranged on a back surface side of a liquid crystal display element, and a diffusion plate, a prism sheet, and the like are arranged between the light source and the liquid crystal display element, whereby uniform plane-shaped light is allowed to enter an entire back surface of the liquid crystal display element.

On the other hand, a sidelight type backlight includes a light guide member arranged on a back surface side of a liquid crystal display element, and a light source arranged so as to be opposed to a side surface of the light guide member (lateral portion of the liquid crystal display element). Light from the light source enters the light guide member from its side surface. The light entering the light guide member is propagated in the light guide member while being totally reflected, and outgoes toward a back surface of the liquid crystal display element.

Conventionally, a CCFL (Cold Cathode Fluorescent Lamp) has been used commonly as a light source of a backlight. In recent years, however, with an advanced development of a LED (Light Emitting Diode) having higher color reproducibility than a CCFL, a LED is used preferably as a light source of a backlight. A LED has an advantage over a CCFL also in that it does not use mercury and lead that are deleterious to living things, and that it consumes less power.

As LEDs, elements that emit light of respective colors such as white (W), red (R), green (G), and blue (B) are known. Although it is also possible to use a white LED alone as a light source, a white LED is relatively expensive, and cannot provide sufficient color reproducibility at least at the present stage. Thus, a technique of obtaining white light by mixing light beams of three primary colors RGB emitted from LEDs is used widely (for example, see JP 2005-196989 A).

JP 2005-196989 A discloses a configuration in which a plurality of LEDs of a plurality of RGB colors are arranged with respect to side surfaces, as light incident surfaces, of a light guide plate 20 on its longitudinal side. In the configuration shown in FIG. 2 of JP 2005-196989 A, a plurality of LEDs are arranged with respect to the light incident surfaces such that a unit alignment of GGRBRGG is repeated. In the configuration shown in FIG. 9 of JP 2005-196989 A, a plurality of LEDs of G are arranged with respect to one of the side surfaces of the light guide plate on its longitudinal side, and a plurality of LEDs of R and B are arranged with respect to the side surface opposed thereto. Further, in the configuration shown in FIG. 10 of JP 2005-196989 A, a plurality of LEDs are arranged with respect to one of the side surfaces of the light guide plate on its longitudinal side such that a unit alignment of GGBGG is repeated, and a plurality of LEDs of R are arranged with respect to the side surface opposed thereto.

Further, in the column of “Color Configuration” on page 4 of “power light source Luxeon™ DCC Technical Datasheet DS48”, [online], Oct. 21, 2003, Lumileds Lighting U.S., LLC, page 4, “Color Configuration”, [searched on Oct. 14, 2005], Internet, <URL: http://www.lumileds.com/pdfs/DS48.pdf>, LED modules including elements arranged as shown in FIG. 15 are disclosed.

### DISCLOSURE OF INVENTION

### Problem to be Solved by the Invention

However, according to the alignment of the elements disclosed in FIG. 2 of JP 2005-196989 A and the alignment (see FIG. 15) of the elements disclosed in “power light source Luxeon™ DCC Technical Datasheet DS48”, the light emitting elements of respective RGB colors are not aligned uniformly, and thus color irregularity is likely to occur in the vicinity of the incident surface.

In view of the above-described problem, an object of the present invention is to suppress the occurrence of color irregularity in the vicinity of an incident surface, so that uniform white light can be obtained on an entire light outgoing surface in the case where light emitting elements of three RGB colors are used as light sources of a surface emitting type illumination device.

### Means for Solving Problem

In order to achieve the above-described object, a first light source device according to the present invention includes: a substrate; and light emitting elements of respective colors including red light emitting elements, green light emitting elements, and blue light emitting elements that emit light in a red wavelength range, light in a green wavelength range, and light in a blue wavelength range, respectively, the light emitting elements being provided on one principal surface of the substrate. The light emitting elements of the respective colors are aligned in a longitudinal direction of the substrate, the light emitting elements of the respective colors are provided so that an amount of the green light emitted is larger than an amount of each of the red light and the blue light emitted, and the light emitting elements of the respective colors in the longitudinal direction of the substrate are aligned at regular intervals for each of the colors.

In order to achieve the above-described object, a second light source device according to the present invention includes: a substrate; and light emitting elements of respective colors including red light emitting elements, green light emitting elements, and blue light emitting elements that emit light in a red wavelength range, light in a green wavelength range, and light in a blue wavelength range, respectively, the light emitting elements being provided on one principal surface of the substrate. The light emitting elements of the respective colors are aligned in a longitudinal direction of the substrate, the light emitting elements of the respective colors are provided so that an amount of the green light emitted is larger than an amount of each of the red light and the blue light emitted, and the light emitting elements of the respective colors are aligned axisymmetrically in the longitudinal direction of the substrate.

Further, in order to achieve the above-described object, an illumination device according to the present invention includes: the light source device according to the present invention; and a light guide member. Light from the light emitting elements of the respective colors in the light source device is incident on at least one side surface of the light guide member, and the incident light is propagated in the light guide member and outgoes from one principal surface of the light guide member.

Further, in order to achieve the above-described object, a liquid crystal display according to the present invention includes: the illumination device according to the present invention; and a liquid crystal display element.

### Effects of the Invention

According to the present invention, in the case where light emitting elements of three RGB colors are used as light sources of a surface emitting type illumination device, it is possible to suppress the occurrence of color irregularity in the vicinity of an incident surface, so that uniform white light can be obtained on an entire light outgoing surface.

### BRIEF DESCRIPTION OF DRAWINGS

FIG. 1 is an exploded perspective view showing a schematic configuration of a backlight device according to Embodiment 1 of the present invention.

FIG. 2 is a cross-sectional view showing a schematic configuration of a liquid crystal display equipped with the backlight device according to Embodiment 1.

FIG. 3 is a schematic diagram showing an arrangement of LEDs of respective colors in a LED unit according to Embodiment 1.

FIG. 4 is an explanatory diagram showing, for each color, the arrangement of the LEDs of respective colors in the LED unit according to Embodiment 1.

FIG. 5 is a schematic diagram for explaining a problem of a comparative example in which a LED unit having a R-LED in the vicinity of an end portion is used, which is given for comparison with the configurations of the LED unit and the backlight device according to Embodiment 1.

FIG. 6 is a schematic diagram showing a modified example of the LED unit according to Embodiment 1.

FIG. 7 is a schematic diagram showing a modified example of the LED unit according to Embodiment 1.

FIG. 8 is a schematic diagram showing a modified example of the LED unit according to Embodiment 1.

FIG. 9 is a schematic diagram showing a modified example of the LED unit according to Embodiment 1.

FIGS. 10A to 10C are schematic diagrams showing modified examples of the LED unit according to Embodiment 1.

FIGS. 11A and 11B are schematic diagrams showing arrangements of LEDs of respective colors in a LED unit according to Embodiment 2.

FIGS. 12A and 12B are schematic diagrams showing configurations of the LEDs included in the LED unit according to Embodiment 2.

FIGS. 13A and 13B are schematic diagrams showing other configurations of the LEDs included in the LED unit according to Embodiment 2.

FIG. 14 is a cross-sectional view showing the configuration of the LED unit according to Embodiment 1.

FIG. 15 is a schematic diagram showing arrangements of LEDs of respective colors in a conventional LED unit described in “power light source Luxeon™ DCC Technical Datasheet DS48”.

### DESCRIPTION OF THE INVENTION

A first light source device according to the present invention includes: a substrate; and light emitting elements of respective colors including red light emitting elements, green light emitting elements, and blue light emitting elements that emit light in a red wavelength range, light in a green wavelength range, and light in a blue wavelength range, respectively, the light emitting elements being provided on one principal surface of the substrate. The light emitting elements of the respective colors are aligned in a longitudinal direction of the substrate, the light emitting elements of the respective colors are provided so that an amount of the green light emitted is larger than an amount of each of the red light and the blue light emitted, and the light emitting elements of the respective colors in the longitudinal direction of the substrate are aligned at regular intervals for each of the colors.

According to the first light source device, the light emitting elements of the respective colors are provided so that an amount of the green light emitted is larger than an amount of each of the red light and the blue light emitted, and the light emitting elements of the respective colors in the longitudinal direction of the substrate are aligned at regular intervals for each of the colors. Thus, in the case where the light from this light source device is incident on a light guide member of a surface emitting type illumination device, the light beams of the respective colors are mixed sufficiently in the vicinity of an incident surface. As a result, the occurrence of color irregularity in the illumination device is suppressed, so that uniform white light can be obtained on an entire light outgoing surface.

A second light source device according to the present invention includes: a substrate; and light emitting elements of respective colors including red light emitting elements, green light emitting elements, and blue light emitting elements that emit light in a red wavelength range, light in a green wavelength range, and light in a blue wavelength range, respectively, the light emitting elements being provided on one principal surface of the substrate. The light emitting elements of the respective colors are aligned in a longitudinal direction of the substrate, the light emitting elements of the respective colors are provided so that an amount of the green light emitted is larger than an amount of each of the red light and the blue light emitted, and the light emitting elements of the respective colors are aligned axisymmetrically in the longitudinal direction of the substrate.

According to the second light source device, the light emitting elements of the respective colors are provided so that an amount of the green light emitted is larger than an amount of each of the red light and the blue light emitted, and the light emitting elements of the respective colors are aligned axisymmetrically in the longitudinal direction of the substrate. Thus, in the case where the light from this light source device is incident on a light guide member of a surface emitting type illumination device, the light beams of the respective colors are mixed sufficiently in the vicinity of an incident surface. As a result, the occurrence of color irregularity in the illumination device is suppressed, so that uniform white light can be obtained on an entire light outgoing surface.

In the first and second light source devices, “the light emitting elements of the respective colors are provided so that an amount of the green light emitted is larger than an amount of each of the red light and the blue light emitted”. This can be achieved by the following configuration: (1) the number of the green light emitting elements is made larger than that of each of the red light emitting elements and the blue light emitting elements, (2) the number of light emitting portions in each of the green light emitting elements is made larger than that of light emitting portions in each of the red light emitting elements and the blue light emitting elements, (3) a surface area of a light emitting portion in each of the green light emitting elements is made larger than that of a light emitting portion in each of the red light emitting elements and the blue light emitting elements, or the like.

Note here that an “amount of light emitted” conceptually indicates a total amount of light emitted from a light source per unit time (per second), and is defined as the number of luminous fluxes (1 m). A luminous flux is obtained by multiplying each wavelength included in a radiant flux [W] by a relative luminous efficiency. In the case where a light emitting surface is a perfect diffusing surface, the luminous flux is obtained as follows: luminous flux (1 m)=π×luminance (cd/m²)×area (m²). Namely, when an amount of light emitted from a light emitting element is larger, the “luminance” (cd/m²), which indicates the intensity of light emitted from a surface in a specific direction, becomes higher.

In the first or second light source device, it is preferable that the red light emitting element is arranged on an inner side relative to the blue light emitting element at an end portion in the longitudinal direction of the substrate. With this configuration, in the case where the light from this light source device is incident on a light guide member of a surface emitting type illumination device, the intensities of light of a long wavelength component (red) and light of a short wavelength component (blue) reflected on a side surface orthogonal to a light incident surface become well balanced in the light guide member. As a result, no color irregularity occurs in the vicinity of the side surface orthogonal to the light incident surface in the light guide member and at four corners of the light guide member, so that uniform white light can be obtained on the entire light outgoing surface of the light guide member.

The first or second light source device can be configured such that an arrangement of the green light emitting element, the blue light emitting element, and the green light emitting element in this order is assumed to be a unit alignment, and the unit alignment and the red light emitting element are arranged repeatedly in the longitudinal direction of the substrate.

More specifically, the light source device may be configured such that an arrangement of the green light emitting element, the blue light emitting element, and the green light emitting element in this order is assumed to be a unit alignment, and at least one combination of the red light emitting element and the unit alignment is arranged on both sides of one of the unit alignments as a center in the longitudinal direction of the substrate. Alternatively, the light source device may be configured such that an arrangement of the green light emitting element, the blue light emitting element, and the green light emitting element in this order is assumed to be a unit alignment, one or a plurality of the unit alignments are arranged on both sides of one of the red light emitting elements as a center in the longitudinal direction of the substrate, and in the case of a plurality of the unit alignments, the red light emitting element is arranged between the respective unit alignments.

The first or second light source device may be configured such that the light emitting elements of the respective colors further include white light emitting elements that emit light in a white wavelength range.

An illumination device according to the present invention includes: the first or second light source device; and a light guide member. Light from the light emitting elements of the respective colors in the light source device is incident on at least one side surface of the light guide member, and the incident light is propagated in the light guide member and outgoes from one principal surface of the light guide member. With this configuration, it is possible to provide an illumination device that can suppress the occurrence of color irregularity, thereby achieving uniform white light on the entire light outgoing surface.

A liquid crystal display according to the present invention includes: the illumination device according to the present invention; and a liquid crystal display element. With this configuration, it is possible to provide a liquid crystal display that can achieve high-definition display since uniform white light can be used as incident light.

Hereinafter, specific embodiments of the present invention will be described with reference to the drawings.

### Embodiment 1

Hereinafter, an embodiment of an illumination device, a light source device used for the same, and a liquid crystal display equipped with the illumination device according to the present invention will be described with reference to the drawings.

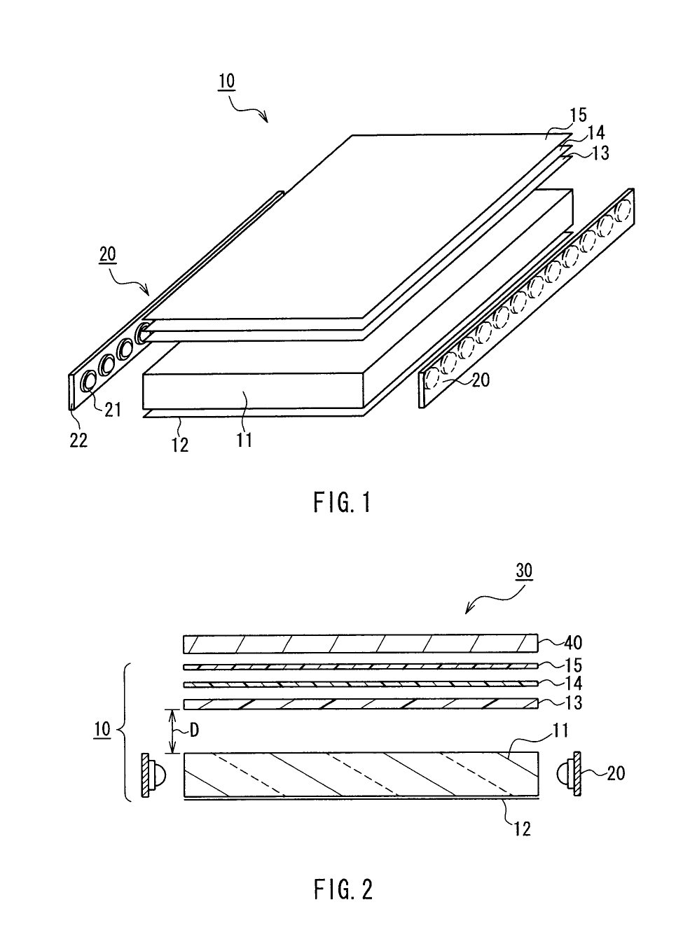

FIG. 1 is an exploded perspective view showing a schematic configuration of a backlight device 10 as an illumination device according to the present embodiment. The backlight device 10 shown in FIG. 1 includes a light guide member 11 in a plate shape, a reflecting sheet 12 laminated on a back surface (principal surface opposed to a light outgoing surface) of the light guide member 11, a diffusion plate 13, a lens sheet 14, and a polarization sheet 15 that are laminated sequentially on the light outgoing surface of the light guide member 11, and two LED units 20 as light source devices. The LED units 20 are arranged so as to be opposed to a pair of side surfaces of the light guide member 11 in a longitudinal direction of its principal surface.

The light guide member 11 is a flat plate made of transparent resin such as acrylic resin. The reflecting sheet 12 can be formed of a polyethylene terephthalate (PET) sheet or a metal sheet that is colored white by dispersing a white pigment thereon or applying a white paint thereto, for example. In the case of a metal sheet, a foil of aluminum, silver, an aluminium alloy, or a silver alloy, or a sheet on which one of these metals is deposited is used, for example. Further, the reflecting sheet 12 also may be formed by superimposing a metal sheet on a lower layer of a white PET sheet.

Each of the LED units 20 has a configuration in which a plurality of LEDs 21 (light emitting elements) are arranged in a line at equal intervals on a surface of a substrate 22. The plurality of LEDs 21 arranged in the LED unit 20 include red LEDs (hereinafter, referred to as R-LEDs) that emit light in a red wavelength range, green LEDs (hereinafter, referred to as G-LEDs) that emit light in a green wavelength range, and blue LEDs (hereinafter, referred to as B-LEDs) that emit light in a blue wavelength range. The alignment of these LEDs of the respective colors in the LED unit 20 will be described later. Although not shown in FIG. 1, a reflector may be provided so as to cover the LED units 20 and light incident surfaces of the light guide member 11 entirely.

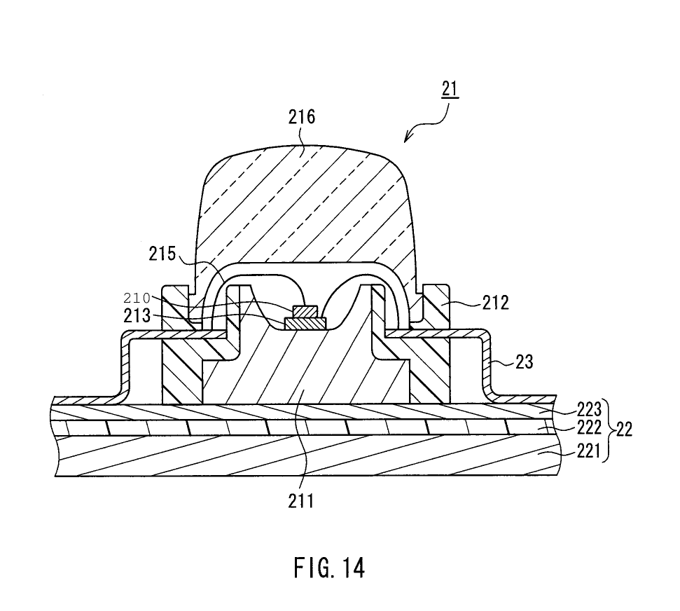

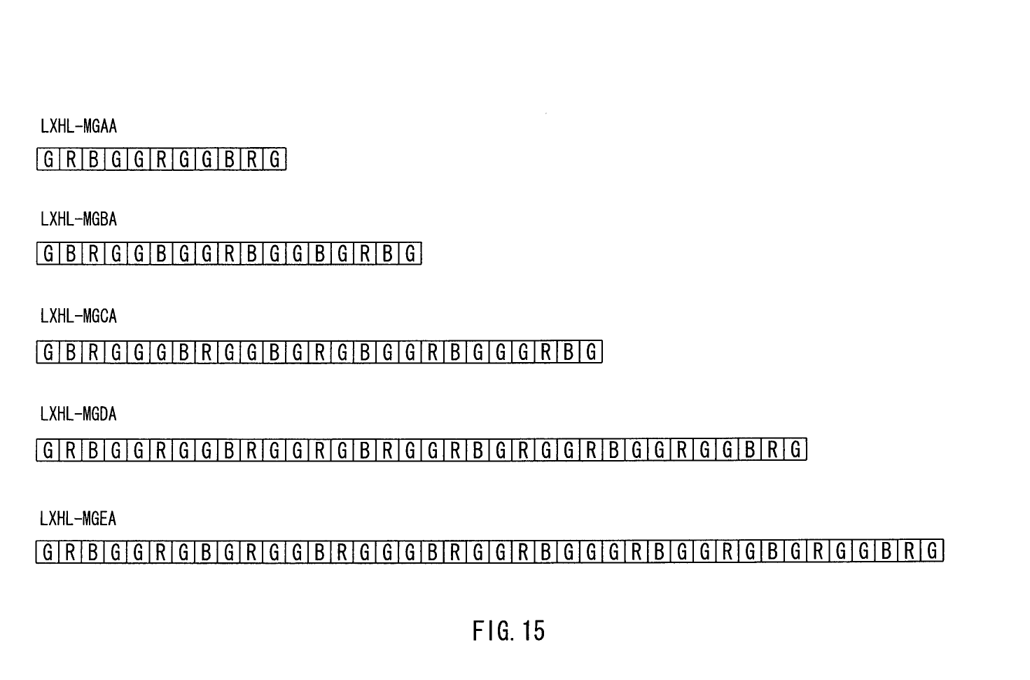

A configuration of each of the LED units 20 will be described in detail. As shown in FIG. 14, each of the red LEDs, the green LEDs, and the blue LEDs used as the LEDs 21 (light emitting elements) includes a heat sink slug 211 formed of a metal having an excellent thermal conductivity, a pedestal 213 arranged in a concave portion on a top surface of the heat sink slug 211, and a tip 210 mounted on the pedestal 213. The pedestal 213 is formed of, for example, solder, a laminated structure of conductive epoxy resin and a silicon substrate, or the like. In the case where the pedestal 213 is formed of solder, the tip 210 is mounted directly on the pedestal 213. In the case where the pedestal 213 is formed by using a silicon substrate, the tip 210 is mounted on the silicon substrate by ball bonding or the like. In the example shown in FIG. 14, the tip is mounted in the concave portion on the top surface of the heat sink slug 211. However, the tip may be mounted without forming the concave portion on the top surface of the heat sink slug 211.

The tip 210 is connected electrically to a lead frame 23 by a gold wire. In the example shown in FIG. 14, the gold wire is bonded to a top surface of the tip 210. However, the portion to which the gold wire is bonded is not limited to this. The lead frame 23 is connected to the substrate 22 of the LED unit 20. The substrate 22 is formed of a laminated structure of an aluminum substrate 221 having a thickness of about 2.0 mm, an epoxy resin layer 222 having a thickness of about 100 μm, and a copper layer 223 having a thickness of about 35 μm.

The heat sink slug 211 is surrounded by a resin cover 212. The resin cover 212 also serves to fix a lens 216 and the lead frame 23. An outer planer shape of the resin cover 212 may be circular as shown in FIG. 1 or rectangular.

The diffusion plate 13 is a semitransparent film or sheet for scattering and diffusing outgoing light from the light guide member 11 so as to obtain uniform brightness on a light emitting surface of the backlight device 10, and is formed of polycarbonate or the like, for example. The lens sheet 14 is provided to improve the luminance of the backlight device 10 in its front direction (a normal direction of the principal surface of the light guide member 11). The lens sheet 14 is formed of a prism lens sheet or the like, for example.

FIG. 2 is a cross-sectional view showing a schematic configuration of a liquid crystal display 30 equipped with the backlight device 10. As shown in FIG. 2, the liquid crystal display 30 as an embodiment of a display device of the present invention is equipped with the backlight device 10 on a back surface of a liquid crystal display element 40.

The liquid crystal display element 40 has a configuration in which liquid crystal is filled in a space between a pair of glass substrates bonded to each other via a sealing material. Regarding the liquid crystal display element 40 capable of being combined with the backlight device 10, its element configuration, drive mode, and the like are arbitrary as long as it is a transmission or semi-transmission liquid crystal display element, and thus a detailed description of the configuration of the liquid crystal display element 40 will be omitted. Note here that an example of the liquid crystal display element 40 is an active matrix type liquid crystal display element using a TFT (Thin Film Transistor) as a driving element. In FIG. 2, a housing for holding the liquid crystal display element 40 and the backlight device 10 integrally is not shown.

As shown in FIG. 2, in the backlight deice 10 of the present embodiment, it is preferable that a predetermined space D is provided between the light guide member 11 and the diffusion plate 13 so that the outgoing light beams from the light guide member 11 are mixed uniformly so as to become white on the entire surface. More specifically, although the light beams of the respective colors entering the light guide member 11 from the R-LEDs, the G-LEDs, and the B-LEDs of the LED unit 20 are mixed when they are propagated in the light guide member 11, the color of the plane-shaped light emitted from the backlight device 10 can be made close to more perfect white (paper-white) by providing the space between the light guide member 11 and the diffusion plate 13. When the space D is larger, less color irregularity occurs due to an improved color mixing property, while the luminance becomes lower due to a reduced amount of light reaching the diffusion plate 13 from the light guide member 11. Thus, while it is difficult to define an optimum distance generally depending on specifications of a backlight, the space D in the backlight device 10 of the present embodiment preferably is about 10 to 20 mm considering a balance between color irregularity and the luminance.

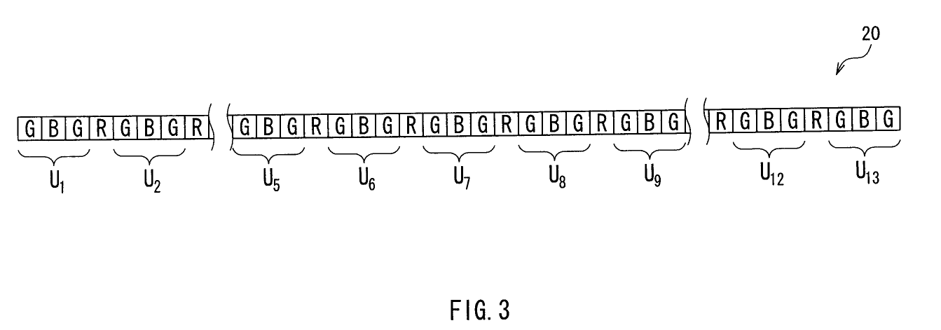

Referring to FIG. 3, an arrangement of the LEDs of the respective colors in the LED unit 20 will be described. As shown in FIG. 3, the LED unit 20 includes the fifty-one LEDs 21 on the substrate 22. As shown in FIG. 3, the LEDs of the respective colors are aligned from an end portion of the substrate 22 in the following manner: GBGRGBGRGBGRGBGRGBGRGBG RGBGRGBGRGBGRGBGRGBGRGBGRGBG. More specifically, the LED unit 20 shown in FIG. 3 has thirteen unit alignments U composed of three of the LEDs 21, i.e., a G-LED, a B-LED, and a G-LED, and includes one R-LED between the unit alignments U, with unit alignments at both end portions of the substrate 22 being U₁ and U₁₃.

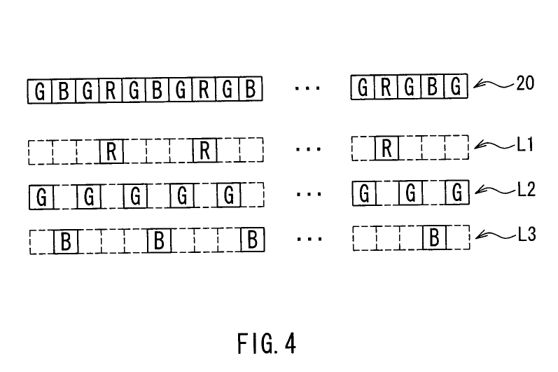

According to this alignment, the arrangement of the LEDs of the respective colors in the LED unit 20 is symmetric (axisymmetric) with respect to a B-LED at the center of unit alignment U₇. FIG. 4 is an explanatory diagram showing, for each of the colors, the arrangement of the LEDs of the respective colors in the LED unit 20. In FIG. 4, L1, L2, and L3 show only the R-LEDs, the G-LEDs, and the B-LEDs, respectively. As can be seen from FIG. 4, the LEDs of each of the colors are arranged at regular intervals in the LED unit 20. More specifically, as shown in FIG. 4, the R-LEDs, the G-LEDs, and the B-LEDs are arranged at equal intervals, i.e., every four elements, every other element, and every four elements, respectively.

As described above, in the LED unit 20, the number of the G-LEDs is larger than that of each of the R-LEDs and the B-LEDs, and the LEDs of the respective colors are arranged symmetrically and at equal intervals. As a result, the light beams emitted from the LEDs of the respective colors are mixed uniformly, so that light whose color is close to more perfect white can be obtained.

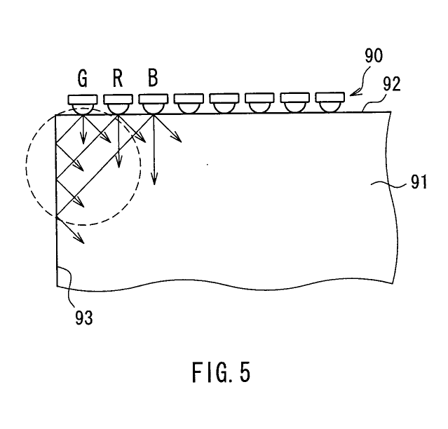

In the LED unit 20 shown in FIG. 3, the unit alignments U₁ and U₁₃ including no R-LED are arranged at both the end portions of the substrate 22, resulting in the following excellent effect. First, referring to FIG. 5, a phenomenon exhibited in the case (comparative example) where a R-LED is arranged in the vicinity of an end portion of a LED unit will be described for comparison with the LED unit 20 shown in FIG. 3. As shown in FIG. 5, in the case of a LED unit 90 as a comparative example having a R-LED in the vicinity of an end portion, light emitted from a G-LED, the R-LED, and a B-LED is reflected on a side surface 93 orthogonal to a surface 92 on which the light from the LED unit 90 is incident in a light guide member 91. The intensities of light beams of respective RGB colors reflected on a common reflective surface are higher in the order of green (G), red (R), and blue (B). In the comparative example in FIG. 5, the G-LED is arranged closest to the side surface 93, and the B-LED is arranged farthest from the side surface 93. Thus, in the case of the comparative example shown in FIG. 5, the blue (B) light has the lowest intensity among the light beams of the respective RGB colors reflected on the side surface 93. As a result, in the case of the comparative example shown in FIG. 5, the intensity of the blue light is insufficient in the vicinity of the side surface 93, and outgoing light becomes yellowish, resulting in color irregularity. In particular, at four corners of the light guide member 91 where the blue light from the B-LED is difficult to reach, the light becomes most yellowish, resulting in remarkable color irregularity.

On the other hand, in the LED unit 20 of the present embodiment shown in FIG. 3, the unit alignments U₁ and U₁₃ including no R-LED are arranged at both the end portions of the substrate 22. Namely, when seen from both the end potions of the substrate 22, the LEDs 21 are arranged in the order of a G-LED, a B-LED, a G-LED, and a R-LED. In other words, in the LED unit 20 of the present embodiment shown in FIG. 3, the B-LED is arranged closer to the end portion of the LED unit 20 than the R-LED is, while in the comparative example in FIG. 5, the R-LED is arranged closer to the end portion of the LED unit than the B-LED is. In this manner, when the three elements of the G-LED, the B-LED, and the G-LED are arranged on an end portion side relative to the R-LED, the intensities of the red (R) light and the blue (B) light reflected on the side surface orthogonal to the light incident surface become well balanced in the light guide member 11. As a result, no color irregularity occurs in the vicinity of the side surface orthogonal to the light incident surface in the light guide member 11 and at four corners of the light guide member 11, so that uniform white light can be obtained on the entire light outgoing surface of the light guide member 11.

As described above, the backlight device 10 according to the present embodiment uses each of the LED units 20 as a light source unit, thereby achieving uniform white light on the entire light outgoing surface of the light guide member 11.

The alignment of the LEDs shown in FIG. 3 is only an example, and the present invention is not limited to this embodiment. In the example in FIG. 3, the same number of the unit alignments U (GBG) are arranged on either side of the single unit alignment U as a center, and the R-LED is arranged between the respective unit alignments U. In addition to this, various other modified examples are also possible.

For example, the number of the unit alignments U arranged on either side of the central unit alignment U is arbitrary. Specifically, the single unit alignment U may be arranged on either side of the central unit alignment U, and a R-LED may be arranged between the unit alignments U, resulting in a LED unit including eleven LEDs. It is also possible to arrange two to five unit alignments U on either side of the central unit alignment U. Further, it is also possible to arrange seven or more unit alignments U on either side of the central unit alignment U, and to arrange a R-LED between the unit alignments U.

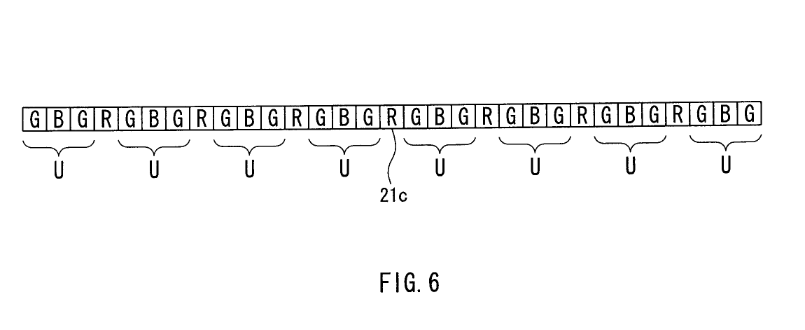

For example, in the example in FIG. 3, the single unit alignment U (GBG) is centered. However, it is also possible that a R-LED is centered, on either side of which the same number of the unit alignments U are arranged, and a R-LED is arranged between the respective unit alignments U. An example of this alignment is shown in FIG. 6. In the alignment shown in FIG. 6, the four unit alignments U are arranged on either side of a R-LED 21c as a center, and a R-LED is arranged between the respective unit alignments U. Also in this alignment, the LEDs of the respective colors on a LED unit are arranged symmetrically, and a R-LED is arranged on an inner side relative to a B-LED at an end portion of the LED unit, resulting in the same effect as that of the configuration shown in FIG. 3.

Further, in the alignment of the LEDs shown in FIG. 3, the unit alignment composed of three of the LEDs (GBG) and the single R-LED are arranged repeatedly on a regular basis. However, as long as the effect of obtaining uniform white light as a whole can be achieved, the alignment may be partially irregular, and such an irregular configuration also is within the technical scope of the present invention.

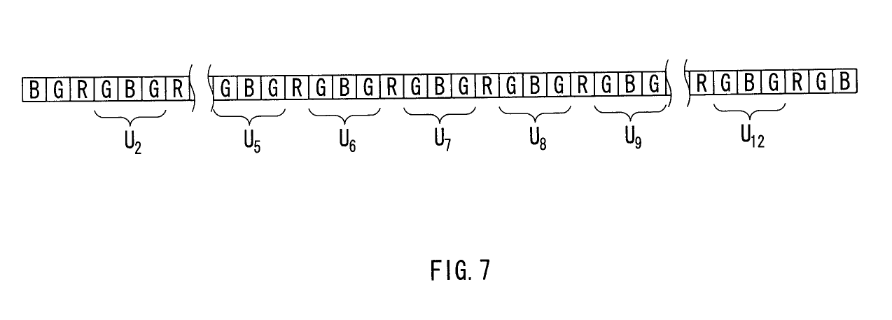

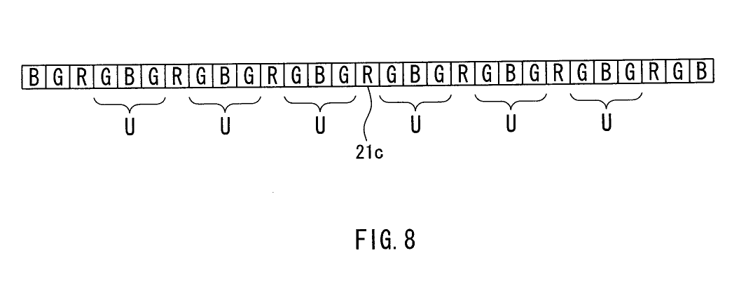

Further, the G-LEDs on both the end portions of the LED alignments shown in FIGS. 3 and 6 may be removed as shown in FIGS. 7 and 8, respectively. Also in each of the configurations in FIGS. 7 and 8, the LEDs of the respective colors on a LED unit are arranged symmetrically, and a R-LED is arranged on an inner side relative to a B-LED at an end portion of the LED unit, whereby uniform white light can be obtained on the entire light outgoing surface of the light guide member 11.

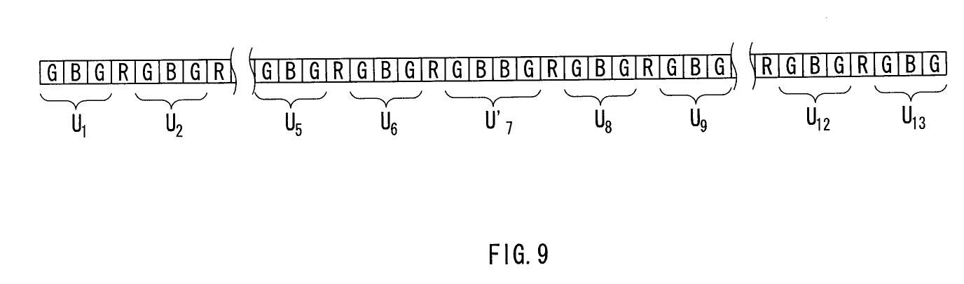

In the configuration example shown in FIG. 3, an odd number (fifty-one) of the LEDs 21 are provided. However, for example, as shown in FIG. 9, the unit alignment U₇ (GBG) in FIG. 3 may be replaced by an alignment U′₇ composed of four LEDs of GBBG, so that the fifty-two LEDs 21 in total may be provided. Also in this configuration, the LEDs of the respective colors on the LED unit 20 are arranged symmetrically, resulting in the same effect as that of the configuration shown in FIG. 3.

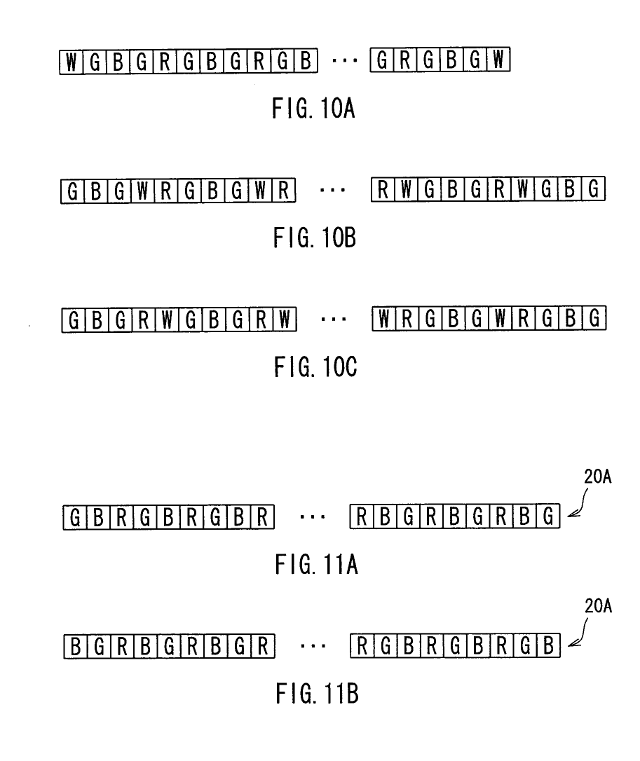

Further, in addition to the LEDs of RGB, a white LED (hereinafter, referred to as a W-LED) may be arranged as appropriate. In such a case, as shown in FIG. 10A, for example, one (or a plurality of) W-LED can be arranged on each end portion of the LED unit 20. Alternatively, as shown in FIG. 10B or 10C, for example, one W-LED can be arranged between the respective unit alignments U. In the configuration shown in FIG. 10A, the W-LED is arranged at the end portion of the LED unit, thereby further suppressing color irregularity due to an intensity difference among the light beams of the respective colors reflected on the side surface orthogonal to the light incident surface in the light guide member. Further, in each of the configurations shown in FIGS. 10B and 10C, the R-LEDs and the B-LEDs are arranged at equal intervals, although the G-LEDs are not arranged at equal intervals, and the LEDs of the respective colors are arranged symmetrically, whereby substantially uniform white light can be obtained.

### Embodiment 2

Another embodiment of the illumination device, the light source device used for the same, and the liquid crystal display equipped with the illumination device according to the present invention will be described with reference to the drawings. The configurations having the same functions as those of the configurations described in Embodiment 1 are denoted with the same reference numerals as in Embodiment 1, and detailed descriptions thereof will be omitted.

A backlight device (illumination device) according to the present embodiment is different from that in Embodiment 1 in that the LED unit 20 described in Embodiment 1 is replaced by a LED unit 20A in which LEDs of respective colors are arranged as shown in FIG. 11A or 11B. Other configurations of the backlight device and a liquid crystal display equipped with the backlight device are the same as those in Embodiment 1.

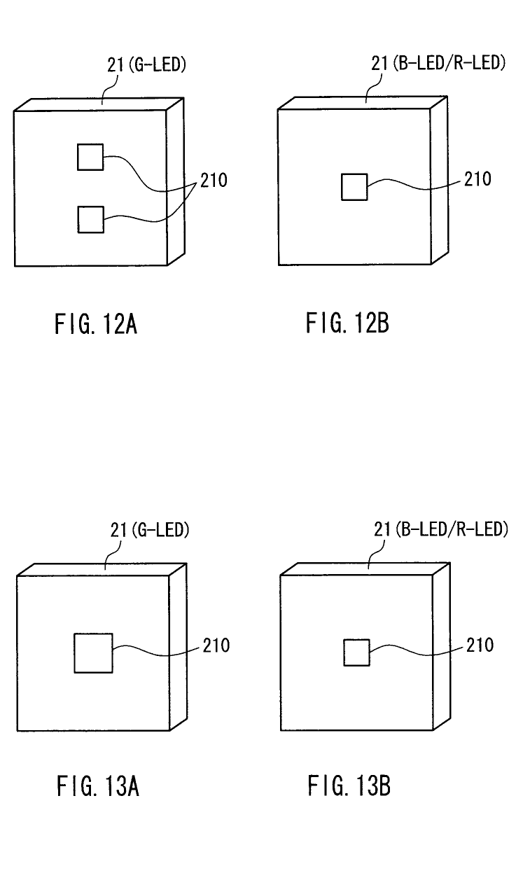

As shown in FIG. 12A, the LED unit 20A of the present embodiment is characterized in that a G-LED of the LEDs 21 has the two tips 210 (light emitting portions). As shown in FIG. 12B, a B-LED and a R-LED each have the single tip 210 (light emitting portion). With this configuration, the G-LED in the LED unit 20A emits light that is about twice as much as that of the B-LED and the R-LED. Consequently, although the LED unit 20A has the same number of the G-LEDs as that of each of the B-LEDs and the R-LEDs, it emits a larger amount of green light. In the LED unit 20A, the LEDs of the respective RGB colors are aligned symmetrically, and thus components of the respective RBG colors are mixed sufficiently, whereby uniform white light can be obtained on an entire light outgoing surface of the light guide member 11. Further, in the LED unit 20A, a R-LED is arranged on an inner side relative to a B-LED at its end portion, thereby suppressing color irregularity due to an intensity difference among light beams of the respective colors reflected on a side surface orthogonal to a light incident surface in the light guide member as in the LED unit 20 described in Embodiment 1.

Instead of the configurations shown in FIGS. 12A and 12B, the tip 210 (light emitting portion) of the G-LED may have a larger surface area, as shown in FIG. 13A, than the tip 210 of each of the B-LED and the R-LED shown in FIG. 13B. Also with this configuration, the LED unit 20A can emit a larger amount of green light. Accordingly, the LEDs of the respective colors shown in FIGS. 13A and 13B also may be arranged as shown in FIG. 11A or 11B, so as to achieve the effect of suppressing color irregularity due to an intensity difference among light beams of the respective colors reflected on a side surface orthogonal to a light incident surface in the light guide member as in the LED unit 20 described in Embodiment 1.

FIGS. 12 and 13 schematically show the position and the size of the tip 210 in the LED 21, and an actual view of the LED 21 is not limited to these embodiments.

In Embodiments 1 and 2, the descriptions have been given of the embodiments of the illumination device (backlight device), the light source device (LED unit) used for the same, and the liquid crystal display equipped with the illumination device according to the present invention. However, the present invention is not limited only to these specific embodiments. For example, although the backlight device including the light guide member in a plate shape has been exemplified in the above-described embodiments, the shape of the light guide member is not limited to a plate shape, and the light guide member may be in a wedge shape, for example. Further, an arbitrary pattern may be formed on a bottom surface or a front surface of the light guide member.

### INDUSTRIAL APPLICABILITY

The present invention is industrially applicable as an illumination device that emits uniform white light as plane-shaped light, a light source used for the same, and a high-definition liquid crystal display using the illumination device.

1-12. (canceled)

13: A light source device comprising:
a substrate; and
light emitting elements of respective colors including red light emitting elements, green light emitting elements, and blue light emitting elements that emit light in a red wavelength range, light in a green wavelength range, and light in a blue wavelength range, respectively, the light emitting elements being arranged so as to be opposed to one side surface of the substrate; wherein
the light emitting elements of the respective colors are aligned in a longitudinal direction of the substrate;
the light emitting elements of the respective colors are arranged so that an amount of the green light emitted is larger than an amount of each of the red light and the blue light emitted; and
the light emitting elements of the respective colors in the longitudinal direction of the substrate are aligned at regular intervals for each of the colors.

14: A light source device comprising:
a substrate; and
light emitting elements of respective colors including red light emitting elements, green light emitting elements, and blue light emitting elements that emit light in a red wavelength range, light in a green wavelength range, and light in a blue wavelength range, respectively, the light emitting elements being provided so as to be opposed to one side surface of the substrate; wherein
the light emitting elements of the respective colors are aligned in a longitudinal direction of the substrate;
the light emitting elements of the respective colors are arranged so that an amount of the green light emitted is larger than an amount of each of the red light and the blue light emitted; and
the light emitting elements of the respective colors are aligned axisymmetrically in the longitudinal direction of the substrate.

15: The light source device according to claim 13, wherein the red light emitting element is arranged on an inner side relative to the blue light emitting element at an end portion in the longitudinal direction of the substrate.

16: The light source device according to claim 13, wherein an arrangement of the green light emitting element, the blue light emitting element, and the green light emitting element in this order is a unit alignment, and
the unit alignment and the red light emitting element are arranged repeatedly in the longitudinal direction of the substrate.

17: The light source device according to claim 16, wherein an arrangement of the green light emitting element, the blue light emitting element, and the green light emitting element in this order is a unit alignment, and at least one combination of the red light emitting element and the unit alignment is arranged on both sides of one of the unit alignments as a center in the longitudinal direction of the substrate.

18: The light source device according to claim 16, wherein an arrangement of the green light emitting element, the blue light emitting element, and the green light emitting element in this order is a unit alignment, one or a plurality of the unit alignments are arranged on both sides of one of the red light emitting elements as a center in the longitudinal direction of the substrate, and in the case of a plurality of the unit alignments, the red light emitting element is arranged between the respective unit alignments.

19: The light source device according to claim 13, wherein the light emitting elements of the respective colors further include white light emitting elements that emit light in a white wavelength range.

20: The light source device according to claim 13, wherein the number of the green light emitting elements is larger than the number of each of the red light emitting elements and the blue light emitting elements.

21: The light source device according to claim 13, wherein the number of light emitting portions in each of the green light emitting elements is larger than the number of light emitting portions in each of the red light emitting elements and the blue light emitting elements.

22: The light source device according to claim 13, wherein a surface area of a light emitting portion in each of the green light emitting elements is larger than a surface area of a light emitting portion in each of the red light emitting elements and the blue light emitting elements.

23: An illumination device comprising:
the light source device according to claim 13; and
a light guide member; wherein
light from the light emitting elements of the respective colors in the light source device is incident on at least one side surface of the light guide member, and the incident light is propagated in the light guide member and exits from one principal surface of the light guide member.

24: A liquid crystal display comprising:
the illumination device according to claim 23; and
a liquid crystal display element.

25: An illumination device comprising:
the light source device according to claim 14; and
a light guide member; wherein
light from the light emitting elements of the respective colors in the light source device is incident on at least one side surface of the light guide member, and the incident light is propagated in the light guide member and exits from one principal surface of the light guide member.

26: A liquid crystal display comprising the illumination device according to claim 25 and a liquid crystal display element.
